(19) United States
(12) Patent Application Publication
(10) Pub. No.: US 2019/0166624 A1
(43) Pub. Date: May 30, 2019

(54) SYSTEMS AND METHODS FOR COMMUNICATION RESOURCE USAGE CONTROL

(71) Applicants: Shayan Mohajer Hamidi, Waterloo (CA); Sanjeewa Herath, Ottawa (CA); Alireza Bayesteh, Ottawa (CA); Amir Keyvan Khandani, Kitchener (CA)

(72) Inventors: Shayan Mohajer Hamidi, Waterloo (CA); Sanjeewa Herath, Ottawa (CA); Alireza Bayesteh, Ottawa (CA); Amir Keyvan Khandani, Kitchener (CA)

(73) Assignee: HUAWEI TECHNOLOGIES CANADA CO., LTD., KANATA (CA)

(21) Appl. No.: 15/824,352

(22) Filed: Nov. 28, 2017

(51) Int. Cl. H04W 74/08; H04W 72/04; H04B 7/04; H04B 1/713; H04W 28/16

(52) U.S. Cl. CPC H04W 74/085; H04W 72/0453; H04W 28/26; H04B 1/713; H04W 28/16; H04B 7/0473

(57) ABSTRACT

A diversity channel for data transmission is obtained by communication equipment. The diversity channel indicates communication resources that are assigned to the communication equipment, and is from a set of diversity channels that are consistent with codewords of a linear code. The communication equipment also transmits a data transmission using the communication resources indicated by the diversity channel. The diversity channel assignment could be determined, by network equipment for example, and information that identifies the diversity channel could be transmitting to the communication equipment. Such information could be explicitly or implicitly signaled to the communication equipment. A set of diversity channels could be generated directly as codewords of one or more linear codes, or additional operations could be applied to such codewords, and possibly other information that is not generated using a code, to provide a diversity channel set.

### FIELD

The present disclosure relates generally to wireless communications and, in particular, to controlling usage of communication resources.

### BACKGROUND

In wireless communication systems, a user equipment (UE) wirelessly communicates with a network equipment such as a base station, to send data to the base station and/or receive data from the base station. A wireless communication from a UE to a base station is referred to as an uplink communication, and a wireless communication from a base station to a UE is referred to as a downlink communication.

Communication resources are required to perform uplink and downlink communications. For example, a UE may wirelessly transmit data to a base station in an uplink communication at a particular frequency and/or during a particular slot in time. The frequency and time slot used are examples of communication resources.

Collisions occur when multiple communications use the same communication resources. For example, without coordination between UEs or communication resource usage control, two or more UEs could each transmit data using the same communication resources, causing a collision.

Such collisions impact communication system performance, and could be reduced or avoided by controlling how communication resources are used.

### SUMMARY

According to an aspect of the present disclosure, a method involves a communication equipment obtaining a diversity channel for data transmission. The diversity channel indicates communication resources that are assigned to the communication equipment. The diversity channel is also from a set of diversity channels that are consistent with codewords of a linear code. The communication equipment also transmits a data transmission using the communication resources indicated by the diversity channel.

Another aspect provides a communication equipment that includes a processor and a transmitter. The processor is configured to obtain a diversity channel for data transmission. As described above and elsewhere herein, the diversity channel indicates communication resources that are assigned to the communication equipment, and is a diversity channel from a set of diversity channels consistent with codewords of a linear code. The transmitter is operatively coupled to the processor, to transmit a data transmission using the communication resources indicated by the diversity channel.

The present disclosure also provides a method that involves determining a diversity channel for data transmission by a communication equipment, and transmitting to the communication equipment information that identifies the diversity channel. As in other embodiments, the diversity channel indicates communication resources that are assigned to the communication equipment, and is from a set of diversity channels consistent with codewords of a linear code.

A network equipment according to a further aspect include a processor and a transmitter. The processor is configured to determine a diversity channel for data transmission by a communication equipment, and the transmitter is operatively coupled to the processor to transmit, to the communication equipment, information that identifies the diversity channel. The diversity channel is from a set of diversity channels consistent with codewords of a linear code, and indicates communication resources that are assigned to the communication equipment.

Non-transitory processor-readable media are also disclosed.

In one aspect, a non-transitory processor-readable medium stores instructions which, when executed by one or more processors, cause the one or more processors to perform a method that involves obtaining, by a communication equipment, a diversity channel for data transmission, and transmitting, by the communication equipment, a data transmission using communication resources indicated by the diversity channel. The diversity channel is from a set of diversity channels consistent with codewords of a linear code, and indicates communication resources that are assigned to the communication equipment.

According to another aspect, a non-transitory processor-readable medium storing instructions which, when executed by one or more processors, cause the one or more processors to perform a method that involves determining a diversity channel for data transmission by a communication equipment, and transmitting to the communication equipment information that identifies the diversity channel. The diversity channel indicates communication resources that are assigned to the communication equipment, and is from a set of diversity channels consistent with codewords of a linear code.

Other aspects and features of embodiments of the present disclosure will become apparent to those ordinarily skilled in the art upon review of the following description.

### BRIEF DESCRIPTION OF THE DRAWINGS

Embodiments will be described in greater detail with reference to the accompanying drawings.

FIG. 1 is a network diagram of a communication system.

FIG. 2 is a block diagram illustrating an example multiple access transmitter chain framework.

FIG. 3 is a block diagram illustrating an example of codeword or diversity channel concatenation.

FIG. 4 illustrates an example of large length diversity channel generation using a Reed-Muller (RM) code.

FIG. 5 illustrates codeword subsets for example RM codes.

FIG. 6 is a flow diagram illustrating an example method according to an embodiment.

FIG. 7 is a flow diagram illustrating another example method.

FIG. 8 is a block diagram illustrating an example of communication resource usage control signaling according to an embodiment.

FIG. 9A is a block diagram illustrating an example UE.

FIG. 9B is a block diagram illustrating example network equipment.

FIG. 10 is a block diagram illustrating an example computing system that may be used for implementing embodiments disclosed herein.

FIGS. 11 and 12 illustrate further example devices that may implement the methods and teachings according to this disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Turning now to the figures, some specific example embodiments will be described.

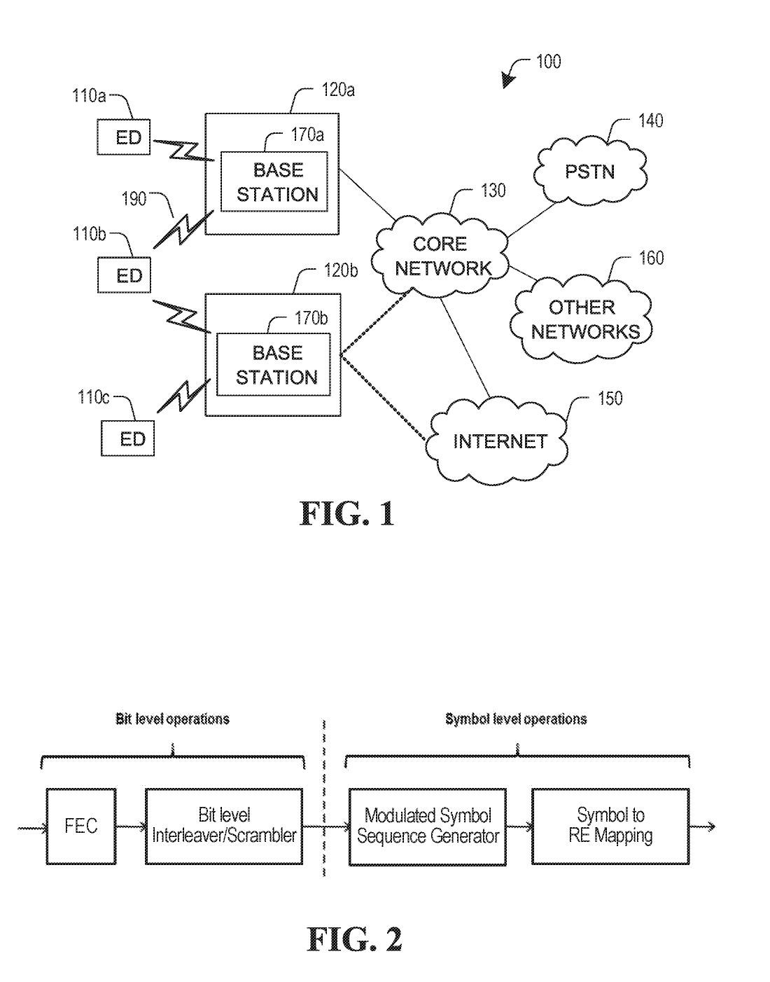

FIG. 1 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, narrowcast, user device to user device, etc. The communication system 100 may operate by sharing communication resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1 any reasonable number of these components or elements may be included in the communication system 100.

The EDs 110a-110c are configured to operate, communicate, or both, in the communication system 100. For example, the EDs 110a-110c are configured to transmit, receive, or both via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission point (TP), a site controller, an access point (AP), or a wireless router. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150, as shown.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+ optionally including HSDPA, HSUPA or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

Multiple Access (MA) schemes support multiple communications, such as communications by the multiple EDs 110a to 110c in FIG. 1. Non-orthogonal multiple access schemes, for example, allow multiple devices, users, or EDs to share the time and frequency resources. The impact of collisions between different communications could be avoided, or at least reduced, by controlling usage of communication resources and by implementing mechanisms/methods to mitigate the harmful impact of potential collisions. Multiple access techniques could be applied to uplink and/or downlink communications.

Considering Non-orthogonal MA (NoMA) schemes, for example, FIG. 2 is a block diagram illustrating an example NoMA transmitter chain framework. It was agreed during the 3^{rd} Generation Partnership Project (3GPP) TSG RAN WG1 Meeting #87 on Nov. 14-18, 2016 (see R1-1611081) that all proposed NoMA schemes for UL transmission would, on a high level, follow the diagram shown in FIG. 2. This example framework includes Forward Error Correction (FEC) encoding and a bit level interleaver/scrambler in the context of bit level operations, and a modulated symbol sequence generator and symbol to Resource Element (RE) mapping in the context of symbol level operations.

Communication resource usage control could involve symbol to RE mapping as shown in FIG. 2. Such mapping could also be considered a form of physical to logical resource mapping. These types of mapping, or communication resource usage control as disclosed herein, are intended to convey the notion of determining the particular communication resources that are to be used for data transmission. This could be considered mapping in that data such as symbols, or logical resources such as user streams, are to be transmitted using certain specific communication resources, and therefore the data or logical resources are “mapped” to the communication resources, or vice versa. In general, controlling usage of communication resources involves some form of determining which communication resources are to be used for transmitting data, and such usage control is inclusive of symbol to RE mapping and physical to logical resource mapping.

Communication resources could be assigned for usage in a UE-specific manner, according to which resources are assigned to UEs. Other assignment conditions or criteria are also possible, to assign communication resources to multiple streams or “layers” associated with the same user for example. Communication resource assignment needs not be limited only to UEs or users, or only for uplink communications. More generally, communication resources could be assigned to communication equipment for use in data transmissions. Such communication equipment could include UEs and/or network equipment, and the data transmissions could include uplink and/or downlink transmissions. Although some embodiments are described herein in the context of assignment of diversity channels to UEs or users for uplink transmissions, these are just illustrative embodiments. Other embodiments could involve communication resource usage control for other types of communication equipment and/or downlink transmissions.

A communication resource assignment or mapping could fully or partially define an MA signature of a UE or other communication equipment, as in Sparse-code multiple access (SOMA), interleave-grid multiple access (IGMA), or pattern division multiple access (PDMA), for example (non-limiting set of examples). Therefore, a set of sequences or patterns from which specific communication resource assignments or mappings could be selected or obtained could define the MA signature fully or partially.

Devices such as base stations (BSs) and/or UEs that are configured to transmit data may use or be assigned different signatures to help a receiver discriminate their transmissions. When different signatures are used, different bit and/or symbol sequences may be generated from the same set of input bits. In that sense, a signature assigned to a device becomes associated with and/or uniquely identifies the particular set of bit or symbol sequences produced by that device. The signature may alternatively be associated with and/or uniquely identify the particular bit domain or symbol domain operation(s) or a combination of bit domain and symbol domains operations used by a device to produce its bit/symbol sequences. The signature could be alternatively associated with and/or uniquely identify the particular module(s)/generator(s), in the bit domain or the symbol domain or a combination thereof, used to produce bit/symbol sequences.

Information that specifies or indicates a communication resource assignment is referred to herein primarily as a diversity channel. It should be appreciated, however, that such information could instead be referred to as: a diversity pattern or sequence; a sparsity channel, pattern, or sequence; a resource channel, pattern, or sequence; or simply a channel, pattern, or sequence, for example. Other terminology could also or instead be adopted.

The present disclosure contemplates diversity channels, and generation of such channels, that are based on a single linear code or multiple linear codes, such as one or more linear block codes. Subsets of codewords of such codes could be selected to indicate communication resources in different resource assignments or mappings. In an embodiment, input parameters for diversity channel generation or selection could include, for example, any of: diversity channel length, resource density or sparsity within each diversity channel, and one or more parameters such as a collision pattern, related to interference or collision between diversity channels.

Diversity channel length refers to a number of entries in a diversity channel, and is also referred to herein as spreading length.

Resource density or sparsity could relate to the number of resources within a diversity channel that are actually assigned or allocated for use in that diversity channel. This is just one example of how sparsity could be introduced.

Generation of a sparse symbol sequence for transmission, for example, refers to generating a set of symbols where at least one of the symbols represents nullity/zero/nil. A nullity/zero/nil symbol could be indicated or represented by a state of communication resource(s). To indicate nullity/zero/nil, the character ‘0’ is used and otherwise the character ‘1’ is used. In one example, a zero constellation point corresponding to a modulation symbol with zero power may represent the zero/nullity/nil. In another case, absence of a symbol/signal in a resource may represent the sparsity. Physical or logical resources such as frequency, time, antenna ports, antenna elements, sub-carriers, REs, beams, frequency bands etc., could be used. These are all examples of communication resources.

Alternatively, a sparse symbol sequence could be generated by puncturing and/or pruning. For example, a non-sparse symbol sequence of length K could be generated and N (N>=1, K>=N) elements are punctured and/or pruned based on a desired sparse pattern, to produce a desired sparse symbol sequence of length K. This is an example of how a diversity channel could actually be applied or used in a data transmission.

Sparsity could also or instead be produced by padding one or more nullity/zero/nil symbols to a sequence of symbols, and then performing symbol level interleaving and/or scrambling. Other methods/possibilities of generating/implementing the sparsity using different resources are not precluded.

As an example of collision, consider the following length 4 diversity channels, which have a density or sparsity of ½: [1 1 0 0]^{T} and [1 0 1 0]^{T}. These diversity channels collide or interfere at the first position, and do not collide or are non-interfering in the second, third, and fourth positions.

Diversity channels with flexible length, resource density or sparsity, and/or collision pattern could be generated or otherwise obtained based on a single linear code or multiple linear codes, and subsets thereof, in accordance with the present disclosure.

The present disclosure also encompasses diversity channels with flexible length, resource density or sparsity, and/or collision pattern, based on combination such as concatenation and/or shortening such as pruning of codewords of a single linear code or multiple linear codes, and subsets thereof.

Some embodiments may also or instead involve diversity channels for adaptive overloading, in which a dynamic number of diversity channels are supported. Such embodiments, and others, could include diversity channel hopping.

Resource density or sparsity of a diversity channel as referenced above can be defined as ρ [symbol] a/N, where N is the total length of the diversity channel, which is also referred to herein as spreading length, and a is a number of non-zero elements in the diversity channel.

As an example, in the following set of diversity channels of spreading length N=4, each of the 6 diversity channels corresponding to a column has a resource density or sparsity ρ=½ with a=2:

| | | | | | |
|---|---|---|---|---|---|
| 0 | 0 | 0 | 1 | 1 | 1 |
| 0 | 1 | 1 | 0 | 0 | 1 |
| 1 | 0 | 1 | 0 | 1 | 0 |
| 1 | 1 | 0 | 1 | 0 | 0 |

In this example, each column represents a diversity channel of length 4 that can be assigned, for example, to respective streams of a single UE or other communication equipment, or to multiple UEs or other communication equipment. The 1s in each column represent particular communication resources such as REs that are usable by a stream or communication equipment to which the diversity channel is assigned, and the 0s in each column represent particular communication resources that are unavailable for use by that stream or communication equipment. Communication resources that are designated with “1” values need not necessarily always be used to carry information. A “1” communication resource could be switched on and off, for example, and therefore be intended to carry “nothing” at certain times. It should also be noted that communication resources that are designated with “0” in any diversity channel could be in use or available for use by other streams or communication equipment in other diversity channels. An RE is an example of a communication resource, and represents a smallest resource unit such as a frequency/time resource that can be assigned for use or for which usage can be selectively controlled. Other examples of communication resources are also provided herein.

Any two diversity channels in the above example differ in at least two positions, and any diversity channel is not interfering in at least one position with any other diversity channel. This means that transmissions using communication resources according to any two diversity channels do not interfere with each other in at least one position. The total number of non-interfering positions or communication resources of any two diversity channels is designated herein as a for ease of reference, and is the minimum hamming distance between the patterns dₘᵢₙ. This could be expressed as α=dₘᵢₙ. In above example, α=2.

Another property of the diversity channels in the above example is that any two patterns collide, at most, in a single position. Therefore, a communication resource that is available (value 1) in one diversity channel is interfered in only one location or resource from any other one of the diversity channels. It should be noted that a communication resource could be intended by one communication equipment to carry no information or a signal of zero power at certain times, for example, and a transmission by another communication equipment using the same communication resource still causes interference or collision in that resource.

The maximum number of tolerable collisions of any two diversity channels is designated herein as β for ease of reference, and is a function of N, ρ and dₘᵢₙ or α. This could be expressed as β=f (N, ρ, dₘᵢₙ). For the diversity channels in the above example, it can be observed that β=1.

Another property of the diversity channels in the above example is that if all diversity channels are assigned to respective streams of a single UE or other communication equipment, or to multiple UEs or other communication equipment, then the sum of collisions for a resource, across all diversity channels, is 3. Although the sum of collisions is 3 for any resource in this example, this is not a general rule. In some examples, a maximum of the sum of the collisions for a resource across all diversity channels, and/or a minimum of the sum of the collisions for a resource, could be used as a parameter that controls overall performance. In the above example, the sum of collisions for each resource is 3 and therefore, the maximum or minimum sum of collisions is also 3. In some embodiments, a sum of collisions parameter such as the maximum, the minimum, a target value for an “equal” sum of collisions for all resources as in the above example, and/or a combination of sum collisions across resources is a parameter that could be designed to control or optimize system performance.

MA systems such as NoMA systems could be interference limited due to, for example, a large number of UEs or other communication equipment, high spectral efficiency transmission, and/or the use of higher code rates etc. In such systems, diversity channels with controlled β might be assigned to UEs or other communication equipment, or to users. Non-interference limited systems might support, for example, a smaller number of UEs or other communication equipment, lower spectral efficiency transmission, and/or the use of lower code rates. Diversity channels with controlled α might be assigned to UEs or other communication equipment, or to users in such systems. Therefore, embodiments of the present disclosure consider, among others, diversity channels of spreading length N with resource density or sparsity ρ for a given α or β. The parameters N, ρ, α, β, and any others such as dₘᵢₙ disclosed herein, are intended solely for illustrative purposes. Diversity channels could be characterized, described, or specified using one or more of these parameters, and/or one or more other parameters.

A set of diversity channels could be generated based on inputs N, p and either α or β. For non-interference limited NoMA systems, diversity channels could be based on codewords of a linear code of codeword length n with the minimum hamming distance dₘᵢₙ≥α where n is the spreading length (N=n), from which a subset of codewords of weight w=ρN is selected. Another way to define codeword weight is the number of non-zeros in a codeword. The set of diversity channels satisfying the input parameters corresponds to the subset, which includes only the selected codewords.

For interference limited NoMA systems, diversity channels could be based on codewords of a linear code of codeword length n with the minimum hamming distance dₘᵢₙ≥2(ρN−β), where n is the spreading length (N=n) as above, from which a subset of codewords of weight w=ρN is selected. Again, the set of diversity channels satisfying the input parameters corresponds to the subset, which includes only the selected codewords. In this example, the criterion dₘᵢₙ≥2(ρN−β) is applied because there are at least two diversity channels that do not collide in ρN−β symbols.

In both of these examples, dₘᵢₙ≤N would also be satisfied.

Turning now to a more detailed example, consider diversity channel design for an interference limited system. This example, and others herein, are intended solely for illustrative purposes. Embodiments are not in any way limited to these examples.

As noted above, β could be a useful design parameter for interference limited systems. In an example of designing a diversity channel with N=n=4, ρ=½, and β=1, then based on the above criterion dₘᵢₙ≥2(ρN−β) a linear code with dₘᵢₙ≥2 would be desired. Using the Singleton bound, i.e., k≤n−dₘᵢₙ+1, we have k≤3. Therefore, in this example an (n, k)=(4,3) linear code, with dₘᵢₙ≥2 is desired.

In an embodiment, a single parity check code with generator matrix G_{n,k} could be used:

G_{4,3}(I₃|P_{3×1}),

where

P_{3×1}=1_{3×1},

1_{3×1} denotes a column vector of size 3×1 with all 1's, and

I₃ is the identity matrix of size 3×3.

The binary block code for this case is as follows, wherein codewords of the code are listed as columns:

| | | | | | | | |
|---|---|---|---|---|---|---|---|
| 0 | 0 | 0 | 0 | 1 | 1 | 1 | 1 |
| 0 | 0 | 1 | 1 | 0 | 0 | 1 | 1 |
| 0 | 1 | 0 | 1 | 0 | 1 | 0 | 1 |
| 0 | 1 | 1 | 0 | 1 | 0 | 0 | 1 |

Based on weight w=ρN=(½)×4=2, a subset of the codewords that satisfy this weight criterion could be selected to define a set of diversity channels for this example. Weight w=2 excludes the first and last columns above, and the desired set of diversity channels, which might also be referred to as a codebook because the set is based on codewords of a code, is thereby obtained. In this example, up to 6 diversity channels with N=n=4, ρ=½, and β=1 can be supported. Up to 8 diversity channels with channels with N=n=4, and β=1 can be supported. The latter example of up to 8 diversity channels is illustrative of an embodiment that does not involve weight-based codeword or diversity channel selection.

Consider another example, with N=n=6, ρ=½, and β=1. From the criterion dₘᵢₙ≥2(ρN−β), a linear code with dₘᵢₙ≥4 is desired. Using the Singleton bound, k≤n−dₘᵢₙ+1, we have k≤3, and therefore a (6,3) linear code with dₘᵢₙ≥4 is desired.

One such code is G_{6,3}=(I₃|P_{3×3}), where

$${P}_{3 \times 3} = ( \begin{matrix}1 & 0 & 1 \\ 1 & 1 & 0 \\ 0 & 1 & 1\end{matrix} ) .$$

The binary block code for this case is as follows, wherein codewords of the code are listed as columns as in the above example:

| | | | | | | | |
|---|---|---|---|---|---|---|---|
| 0 | 0 | 0 | 0 | 1 | 1 | 1 | 1 |
| 0 | 0 | 1 | 1 | 0 | 0 | 1 | 1 |
| 0 | 1 | 0 | 1 | 0 | 1 | 0 | 1 |
| 0 | 0 | 1 | 1 | 1 | 1 | 0 | 0 |
| 0 | 1 | 1 | 0 | 0 | 1 | 1 | 0 |
| 0 | 1 | 0 | 1 | 1 | 0 | 1 | 0 |

Based on weight w=ρN=(½)×6=3, a subset of the codewords that satisfy this weight criterion could be selected to define a set of diversity channels for this example. The subset of codewords with weight w=3 includes the codewords in columns 2, 3, 5, and 8. Collisions are possible in 1 location (β=1) between any two diversity channels corresponding to these selected columns or codewords. There are also 4 locations between any two of these diversity channels that are non-interfering or non-colliding (dₘᵢₙ=4). With these 4 selected columns or codewords, up to 4 diversity channels can be supported.

With the same code and the same set of codewords, a subset of codewords for ρ=⅔ and weight w=4 could also be selected. Under this weight criterion, the codewords in columns 4, 6, and 7 are selected. Only 2 locations (β=2) between any two diversity channels are colliding or interfering, and 4 locations are non-colliding or non-interfering (dₘᵢₙ=4).

By selecting codewords for both w=3 and w=4 (corresponding to ρ=½ and ρ=⅔, respectively), flexible resource density or sparsity could be supported. By using multiple diversity channels with different sparsity, a system can be semi-statically or dynamically configured to operate with different numbers of diversity channels. Flexible resource density could also provide multiple spectral efficiencies for a single UE or multiple UEs and/or other types of communication equipment.

As another example, consider N=n=6, β=⅓, and β=1. According to the criterion dₘᵢₙ≥2(ρN−β) a linear code with dₘᵢₙ≥2 is desired. Based on the Singleton bound, k≤n−dₘᵢₙ+1, we have k≤5 in this example, for a (6,5) linear code with dₘᵢₙ≥2. Under these conditions, the single parity check code G_{6,5}=(I₅|1_{5×1}) where 1_{5×1}=(1 1 1 1 1)^{T} could be used to generate codeword candidates for a set of diversity channels.

The subset of codewords of weight 2 (with dₘᵢₙ=2) includes the following:

| | | | | | | | | | | | | | | |
|---|---|---|---|---|---|---|---|---|---|---|---|---|---|---|
| 0 | 0 | 0 | 0 | 0 | 0 | 0 | 0 | 0 | 0 | 1 | 1 | 1 | 1 | 1 |
| 0 | 0 | 0 | 0 | 0 | 0 | 1 | 1 | 1 | 1 | 0 | 0 | 0 | 0 | 1 |
| 0 | 0 | 0 | 1 | 1 | 1 | 0 | 0 | 0 | 1 | 0 | 0 | 0 | 1 | 0 |
| 0 | 1 | 1 | 0 | 0 | 1 | 0 | 0 | 1 | 0 | 0 | 0 | 1 | 0 | 0 |
| 1 | 0 | 1 | 0 | 1 | 0 | 0 | 1 | 0 | 0 | 0 | 1 | 0 | 0 | 0 |
| 1 | 1 | 0 | 1 | 0 | 0 | 1 | 0 | 0 | 0 | 1 | 0 | 0 | 0 | 0 |

For this codeword subset of weight w=2, there is only a single colliding or interfering location (β=1) between any two diversity channels, which is the desired property of the β parameter in this example. Between any two of these codewords or corresponding diversity channels, 2 locations are non-colliding or non-interfering (dₘᵢₙ=2). In this example codeword subset, up to 15 diversity channels can be supported.

A subset of codewords of the same G_{6,5} code but with weight 4 (with dₘᵢₙ=2) includes the following:

| | | | | | | | | | | | | | | |
|---|---|---|---|---|---|---|---|---|---|---|---|---|---|---|
| 0 | 0 | 0 | 0 | 0 | 1 | 1 | 1 | 1 | 1 | 1 | 1 | 1 | 1 | 1 |
| 0 | 1 | 1 | 1 | 1 | 0 | 0 | 0 | 0 | 1 | 1 | 1 | 1 | 1 | 1 |
| 1 | 0 | 1 | 1 | 1 | 0 | 1 | 1 | 1 | 0 | 0 | 0 | 1 | 1 | 1 |
| 1 | 1 | 0 | 1 | 1 | 1 | 0 | 1 | 1 | 0 | 1 | 1 | 0 | 0 | 1 |
| 1 | 1 | 1 | 0 | 1 | 1 | 1 | 0 | 1 | 1 | 0 | 1 | 0 | 1 | 0 |
| 1 | 1 | 1 | 1 | 0 | 1 | 1 | 1 | 0 | 1 | 1 | 0 | 1 | 0 | 0 |

For this subset of codewords, with N=n=6 as above but with weight w=4, resource density or sparsity is ρ=⅔. There are 3 collision or interference locations (β=3) between any two codewords or corresponding diversity channels, and 2 symbol locations are non-colliding or non-interfering (dₘᵢₙ=2). The weight w=4 subset can be used to support up to 15 diversity channels.

In this example, as in another example described above, flexible resource density or sparsity can be supported by selecting codewords of multiple weights, including w=3 and w=4 in this example. These particular examples of flexible resource density or sparsity involve selection of different weight codewords from the same code. In other embodiments, however, codewords of different weights could be selected from codewords of multiple different codes, to support flexible resource density or sparsity.

From a block code design perspective, systematic and non-systematic codes may result in the same dₘᵢₙ or distance properties. When codes are used for actually encoding data, code performance and/or other parameters might be taken into account when selecting a particular code, and there could be a preference for systematic codes over non-systematic codes, for example. According to aspects of the present disclosure, however, codewords are used as diversity channels and therefore code performance and other parameters that impact selection of codes for data coding might not necessarily affect code selection for diversity channel design.

A systematic code is a code that can be generated from a generator matrix of the form (I_{N}|P_{N×K}). The generator matrix is a block matrix in which an identity matrix followed by another matrix that matches the size of the identity matrix. Generator matrices of non-systematic codes do not follow the (I_{N}|P_{N×K}) form. Diversity channels could be based on codewords of systematic codes or codewords of non-systematic codes. Codewords of either of these types of codes could satisfy the distance properties and/or other parameters that are disclosed herein.

In the present disclosure, diversity channels are consistent with codewords of a code. Diversity channels that correspond to codewords generated from one or more linear codes are clearly consistent with those codewords. A set of diversity channels could be pre-generated using codewords of one or more linear codes and stored for later use. Even though such codewords might not be generated at the time that they are used as diversity channels, and/or might not even be generated by a communication device that actually uses the codewords as diversity channels, the diversity channels are still consistent with those codewords.

Codewords and corresponding diversity channels could be generated using one or more code generator matrices in which columns or rows are permuted. Such diversity channels are still considered to be consistent with codewords of a code for the purposes of the present disclosure.

Similarly, operations such as interleaving and/or scrambling could be applied to codewords of one or more codes to generate final diversity channels. Even in this scenario, the diversity channels are still based on or consistent with codewords of a code.

Diversity channels in which the 1s are concentrated, or in other words the 1s are not dispersed or distributed with one or more 0s between them, can cause higher Peak to Average Power Ratio (PAPR) and overall poor performance. Interleaving or scrambling of a diversity channel is one approach to potentially avoid this situation. In another example, diversity channel generation could define a constraint or a rule to avoid such concentrated patterns. As an example, a unique codeword results from each unique set of input bits of length k to a generator matrix G of a linear code. Therefore, by controlling or limiting to certain input bit sequences, corresponding undesired output codewords and diversity channels can be avoided. Use of non-systematic linear codes is another example of an approach that could avoid codewords and diversity channels with undesired patterns.

Scrambling and/or interleaving could be specific to a group of diversity channels. Such group-specific operations could, for example, be used to average out or otherwise affect interference among user groups. Consider a scenario in which UEs served by two different neighboring base stations (BSs) are assigned the same diversity channels but each BS is configured to use BS-specific scrambling and/or interleaving of the diversity channels. This way, interference from neighboring BS UEs/layers could be controlled, and averaged out for example.

Group-specific scrambling and/or interleaving is not limited to groups of UEs/layers served by different BSs, but is more generally applicable to any grouping of diversity channels. In embodiments in which very large numbers of connections are served by BSs such as in a Massive Machine Type Communication (MMTC) use case for example, UEs/layers within the same BS could be clustered/grouped together and treated differently from other groups. Other groupings of diversity channels could also or instead be used in applying group-specific operations to provide final diversity channels.

As another example, multiple layers of the same UE or other communication equipment could use the same diversity channel but scrambled and/or interleaved in a layer-specific manner. This could facilitate multi-layer transmission without assigning separate diversity channels, but the layers are still decoded/separated by the layer-specific scrambling/interleaving. This could also help reduce signaling.

These potential benefits of group-specific and/or layer specific operations could be in addition to possible PAPR improvements from scrambling/interleaving, which are also described above.

Codewords and corresponding diversity channels generated from one or more linear codes may provide different resource density or sparsity, with controlled α and/or β. Diversity channel generation or selection could be configured to use single or multiple resource density criteria, as in several examples above. Single weight codeword sets each provide a specific resource density or sparsity, and codeword sets including codewords of multiple different weights provide flexible resource density or sparsity. The different-weight codeword sets could include codeword sets associated with the same code or multiple different codes. Flexible resource density or sparsity could be useful, for example, to cater to higher overloading, to support higher spectral efficiency, to exploit/optimize for receiver capability, and/or in other applications or scenarios.

In some embodiments, multiple diversity channels could be allocated or assigned to a user, UE, or other communication equipment, and different ones of those diversity channels could be used at different times or under different conditions. In order to randomize or at least vary interference, the diversity channels that are used in a link could be hopped. A pattern for changing between different diversity channel could be defined in a hopping pattern, for example.

Embodiments could involve hopping between diversity channels or otherwise changing diversity channels during transmission of a single packet, or between multiple packets. Any of various conditions or parameters, including multiple conditions or parameters, could trigger a change between different diversity channels. Trigger conditions or parameters could be time-based, packet-based, and/or based on some other type of transmission block. These are illustrative examples of conditions or parameters that could trigger a change in diversity channels. Others are also possible, and may be apparent to those skilled in the art.

The different diversity channels that are used in diversity channel hopping could include diversity channels that are consistent with codewords from a single code or multiple codes, and/or codewords having the same weight or different weights. Different-weight codeword sets could be used to implement diversity channel hopping with flexible resource density or sparsity.

Diversity channel assignments could be specified, for example, using indices. In the set of diversity channels corresponding to the subset of codewords of weight 2 (with dₘᵢₙ=2) from G_{6,5} which is provided in an example above and is repeated below for ease of reference,

| | | | | | | | | | | | | | | |
|---|---|---|---|---|---|---|---|---|---|---|---|---|---|---|
| 0 | 0 | 0 | 0 | 0 | 0 | 0 | 0 | 0 | 0 | 1 | 1 | 1 | 1 | 1 |
| 0 | 0 | 0 | 0 | 0 | 0 | 1 | 1 | 1 | 1 | 0 | 0 | 0 | 0 | 1 |
| 0 | 0 | 0 | 1 | 1 | 1 | 0 | 0 | 0 | 1 | 0 | 0 | 0 | 1 | 0 |
| 0 | 1 | 1 | 0 | 0 | 1 | 0 | 0 | 1 | 0 | 0 | 0 | 1 | 0 | 0 |
| 1 | 0 | 1 | 0 | 1 | 0 | 0 | 1 | 0 | 0 | 0 | 1 | 0 | 0 | 0 |
| 1 | 1 | 0 | 1 | 0 | 0 | 1 | 0 | 0 | 0 | 1 | 0 | 0 | 0 | 0 |

indices from 1-15 could uniquely identify each codeword and therefore uniquely identify each corresponding diversity channel. Such indices could then be used to indicate diversity channels assignments, for example. A unique communication equipment or user identifier, modulo the size of the diversity channel set or pool, 15 in this example, could determine the diversity channel that is assigned to a communication equipment or user. A Radio Network Temporary Identifier (RNTI) is an example of such a unique identifier, and RNTI mod 15 could be used in conjunction with diversity channel indices to determine a diversity channel assignment. Other types of indices and/or identifiers could be used in a similar manner to denote particular diversity channels and specify or determine diversity channel assignments.

A set or pool of codewords and corresponding diversity channels need not be restricted to a single resource density or code. For example, the above subset of codewords of weight 2 (with dₘᵢₙ=2) from G_{6,5} could be combined with the first 4 codewords in the subset of codewords of weight 4 (with dₘᵢₙ=2) from G_{6,5} to provide the following set or pool of 19 codewords and corresponding diversity channels:

| | | | | | | | | | | | | | | | | | | |
|---|---|---|---|---|---|---|---|---|---|---|---|---|---|---|---|---|---|---|
| 0 | 0 | 0 | 0 | 0 | 0 | 0 | 0 | 0 | 0 | 1 | 1 | 1 | 1 | 1 | 0 | 0 | 0 | 0 |
| 0 | 0 | 0 | 0 | 0 | 0 | 1 | 1 | 1 | 1 | 0 | 0 | 0 | 0 | 1 | 0 | 1 | 1 | 1 |
| 0 | 0 | 0 | 1 | 1 | 1 | 0 | 0 | 0 | 1 | 0 | 0 | 0 | 1 | 0 | 1 | 0 | 1 | 1 |
| 0 | 1 | 1 | 0 | 0 | 1 | 0 | 0 | 1 | 0 | 0 | 0 | 1 | 0 | 0 | 1 | 1 | 0 | 1 |
| 1 | 0 | 1 | 0 | 1 | 0 | 0 | 1 | 0 | 0 | 0 | 1 | 0 | 0 | 0 | 1 | 1 | 1 | 0 |
| 1 | 1 | 0 | 1 | 0 | 0 | 1 | 0 | 0 | 0 | 1 | 0 | 0 | 0 | 0 | 1 | 1 | 1 | 1 |

This example supports up to 19 diversity channels and could be indexed using index numbers 1-19, for example. Diversity channel assignments could be determined by RNTI mod 19 in one embodiment.

With index-based diversity channel identification, a hopping pattern could also be index-based. For example, a hopping pattern could be defined in terms of a starting index and an offset, such as:

(Start index+i*Offset)mod(size of the diversity channel set or pool),

where i=0, 1, . . . is a transmission index. The transmission index could be incremented at each hopping trigger, such as after a certain time for time-based hopping or after each packet for packet-based hopping, for example.

A different starting index in a diversity channel set or pool could be assigned to each user or communication equipment, for example, using a unique identifier as described above, such as RNTI mod (size of the diversity channel set or pool). Offsets could then be the same or different for each user or communication equipment. Start index could instead be the same for all users or communication equipment, and offsets could be different per user or communication equipment, based on a unique user or communication equipment identifier for example.

Hopping patterns are described above with reference to codeword or diversity channel indices. In other embodiments, hopping patterns could be specified in other ways. For example hopping could be based on information bit domain indices. In an example described above, a unique codeword results from each unique set of input bits of length k to a generator matrix G of a linear code. Therefore, indices of information bit sequences or inputs could be used to define hopping patterns.

Is some scenarios, a linear code of length n with desired properties might not fit well with target spreading length N, resource density ρ, and/or other target parameters or conditions. Codeword length n could be restricted, for example. Consider a Hamming code, in which n=2^{m}−1 with m≥3. For such a code, n=7, 15, 31 . . . can be constructed.

Input parameters such as N, ρ, α, β for diversity channel generation or selection could also vary depending on system requirements, operating conditions, and/or other characteristics. Such characteristics as the number of users in a system, PAPR requirements, the amount of available/affordable/allocated bandwidth, overloading/spectral efficiency/Modulation Coding Set (MCS) requirements, receiver capabilities, and/or possibly others could impact diversity channel generation or selection parameters. Input parameter variation could be dynamic, involving different diversity channel sets, or non-dynamic, involving diversity channels selected from different parts or segments of a single set of diversity channels.

Support for flexible diversity channels could be provided in this type of scenario, in which desired diversity channel properties or characteristics may change. For example, multiple codewords of a single linear code (including a single weight or multiple weights of the same code), same-weight or different-weight codewords of multiple linear codes, or codewords from subsets of one or more such codes could be concatenated or otherwise combined into diversity channels of length N greater than the code length n of the single code or any of the multiple codes.

Multiple codewords that are selected in a computer search rather than being directly generated “on-the-fly” from one or more codes could similarly be combined. For example, for smaller N, a codeword or diversity channel search could involve an acceptable level of computational complexity relative to direct codeword generation.

Shortening operations such as pruning or puncturing rows from codeword sets or computer searched diversity channels could be used to generate shorter diversity channels. These operations could be performed on base codewords generated using one or more codes or base diversity channels located in a computer search, or on combined codewords or diversity channels. For example a length N=10 diversity channel could be generated by pruning or puncturing a length n=15 codeword, or by pruning or puncturing a concatenation of two length n=7 codewords.

In all of these examples involving combination or shortening, diversity channels are still based at least in part on codewords of one or more linear codes. At least in this sense, the final diversity channels can be considered to be consistent with codewords of one or more linear codes.

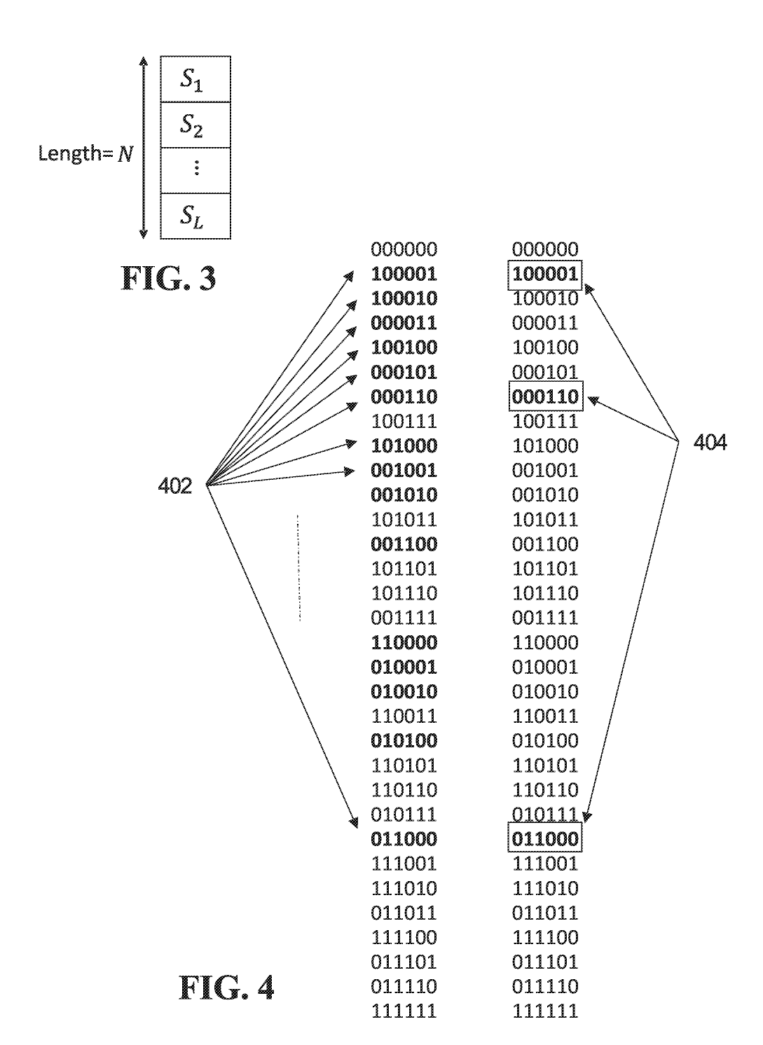

Considering concatenation of multiple codewords or diversity channels in more detail, an example is described below with respect to concatenating diversity channels. Such concatenation could be applied to codewords. A set or pool of diversity channels of length N could be constructed by concatenating diversity channels Sᵢ, i=1, . . . , L, where Sᵢ ∈ Aᵢ. Aᵢ represents a set or pool of diversity channels and Sᵢ is of length Nᵢ with N=Σᵢ₌₁^{L} Nᵢ. This is shown by way of example in FIG. 3. For any Sₘ, Sₙ, n≠m, and Sₘ ∈ Aᵢ and Sₙ ∈ Aᵢ. The same diversity channel could be used more than once in a concatenation, and a concatenation could also or instead include different diversity channels. Permutations of diversity channels in the locations 1, . . . , L in FIG. 3 produce distinct diversity channels of length N=Σᵢ₌₁^{L} Nᵢ.

Diversity channels (Aᵢ, i=1, . . . , L) could be obtained from, for example:

different weight codewords of a single linear code or multiple linear codes;

subsets of the same or different weight codewords of a single linear code or multiple linear codes; and/or

a computer search, randomly generated selection, or down selection from a larger set or pool of diversity channels that meets one or more specific performance metrics.

Example performance metrics include: resource density or sparsity, maximum possible collisions in a given position (interference to a given diversity channel from other diversity channels), total possible collisions of a given diversity channel (the sum of 1s, analogous to the weight of a codeword), and possibly others.

The above examples are not the only sources of codewords or data that could be concatenated for diversity channel generation. For example, diversity channels could be based in part on codewords of a linear code, which are concatenated with vectors or data that are not code-generated. An identity matrix such as I₄

| | | | |
|---|---|---|---|
| 1 | 0 | 0 | 0 |
| 0 | 1 | 0 | 0 |
| 0 | 0 | 1 | 0 |
| 0 | 0 | 0 | 1 |

is not code-generated, but could be used as a set of weight 1 vectors or words for concatenation with codewords of one or more code. Another example is the following set of words of weight 2, which again need not necessarily be code-generated

| | |
|---|---|
| 1 | 0 |
| 1 | 0 |
| 0 | 1 |
| 0 | 1. |

Diversity channels that are generated by concatenating or otherwise combining code-generated codewords with words or data that might not be generated using a code are still based in part on codewords and therefore in at least this way are consistent with codewords of a linear code for the purposes of the present disclosure.

As noted above, a set or subset of codewords or corresponding diversity channels could be defined or referenced using indices of codewords or diversity channels. Indices could also or instead be used to reference indices of input bits of a linear code from which particular codewords are generated. Codeword or diversity channel selection criteria or restrictions could constrain the weight of codewords or diversity channels (the number of non-zeros in a codeword or diversity channel) or resource density/sparsity. The number of the interfering codewords or diversity channels (the number of non-zeros in a row of a codeword or diversity channel set or subset) could also or instead be constrained.

For codeword or diversity channel concatenation, any set or subset of codewords or diversity channels could be concatenated to produce a higher length codeword or diversity channel. Component sets or subsets for concatenation, or other types of combination, could be selected based on such parameters as any one or more of: length of the desired codewords or diversity channels, a constraint on resource density or sparsity, weight of the codewords or diversity channels, a constraint on interference from other codewords or diversity channels, and possibly others.

Concatenation is one example of combining codewords with other codewords, or with other information or data that might not be generated using a code. As another example of a combination, consider the Cartesian product of set A (the subset of codewords of weight 2 (with dₘᵢₙ=2) from G_{6,5}, listed above) with itself (set B=set A) once (L=2) to produce codewords or diversity channels N=12, ρ=⅓ with β=2 (with dₘᵢₙ=4), as A×B with positions (a ∈ A, b ∈ B).

The Cartesian product of the subset of codewords of weight 2 and dₘᵢₙ=2 from G_{6,5} with I₆ (L=2) represents another example of a combination, which could be used to produce codewords or diversity channels N=12, ρ=⅓ with β=2 (with dₘᵢₙ=4). In this example, the codewords or diversity channels are based in part on codewords of a linear code G_{6,5}, combined with a vector that is not code-generated. Diversity channels that are generated in this way are still considered to be consistent with codewords of a linear code for the purposes of the present disclosure, at least because those diversity channels are based, in part in this example, on linear block codewords.

As another example, the Cartesian product of the subset of codewords of weight 2 with dₘᵢₙ=2 from G_{6,5} with the subset of codewords of weight 4 with dₘᵢₙ=2 from G_{6,5} (L=2) could be used to produce codewords or diversity channels N=12, ρ=½ with β=4 (with dₘᵢₙ=4). This example illustrates combination of different-weight subsets based on the same code, but same-weight or different-weight subsets based on different codes could be combined in other embodiments.

These examples relate to combinations that are based at least in part on code-generated codewords or diversity channels. Sets, subsets, or pools that are pre-generated and obtained from computer searches could also or instead be combined.

Codewords or diversity channels of larger length, whether directly code-generated, located by computer search, or resulting from combination, could be shortened, by pruning or puncturing for example, to construct smaller length codewords or diversity channels. Pruning could involve removing a row of a generator matrix of the linear code, for example, and not just pruning one or more rows from a codeword matrix.

Similar to combination, parameters that could influence shortening might include one or more of: overloading support, target spectral efficiency, MCS requirements, and/or receiver capabilities, for example.

Shortening could take into account such design constraints or conditions as desired length of codewords or diversity channels (spreading length), resource density or sparsity, a, β, desired weight of the codewords or diversity channels, collision/interference patterns, and/or possibly others.

The codeword and diversity channel examples above are relatively short (up to N=12 in the combination examples), and are based on particular code examples. Other codes and longer base code lengths are also contemplated. When desired codewords or diversity channels length is large, more structured codes could be preferred. Examples of such codes include Hamming codes, RM codes, single-error correcting double error detecting (SEC-DED) codes, cyclic codes, convolutional codes, Turbo codes, Low Density Parity Check (LDPC) codes, and Polar codes. Other types of forward error correction codes may also be apparent to those skilled in the art.

Generation of codewords and corresponding diversity channels using more structured codes could be easier compared to other codes, with control of codeword generation using such input parameters as N, α, β, ρ. Higher length codewords and corresponding diversity channels can encompass higher numbers of resources such as REs. A set or pool of codewords and corresponding diversity channels could be larger for larger length codewords and corresponding diversity channels compared to shorter length codewords and corresponding diversity channels, to potentially provide for higher overloading support.

In addition, with more structured underlying codes, additional structures of the codes could be exploited. Consider an RM code as an example, in a scenario in which overloading based on a number of interfering communication equipment such as UEs varies in a slow varying process. Codewords and corresponding diversity channels could be taken from an RM code with suitable dₘᵢₙ and one or more subsets of the codewords having larger dₘᵢₙ could be used as a set or pool of diversity channels. In this example, multiple subsets of codewords from the same RM code could be used, but in other embodiments codewords from multiple RM codes could be used.

FIG. 4 illustrates an example of large length diversity channel generation using an RM code, in particular a (6,5,2) code. In FIG. 4, a weight 2 sub-set of codewords is composed of 15 elements, denoted 402 in the drawing, and dₘᵢₙ between any two of those elements is 2. A subset of 3 elements in the weight 2 subset have a dₘᵢₙ of 4, and the dₘᵢₙ=4 subset is denoted 404 in FIG. 4. In this example, a base station could use and/or signal communication equipment such as a UE to use the dₘᵢₙ=2 subset 402 under certain conditions, and use and/or signal to use the dₘ=4 subset 404 under other conditions.

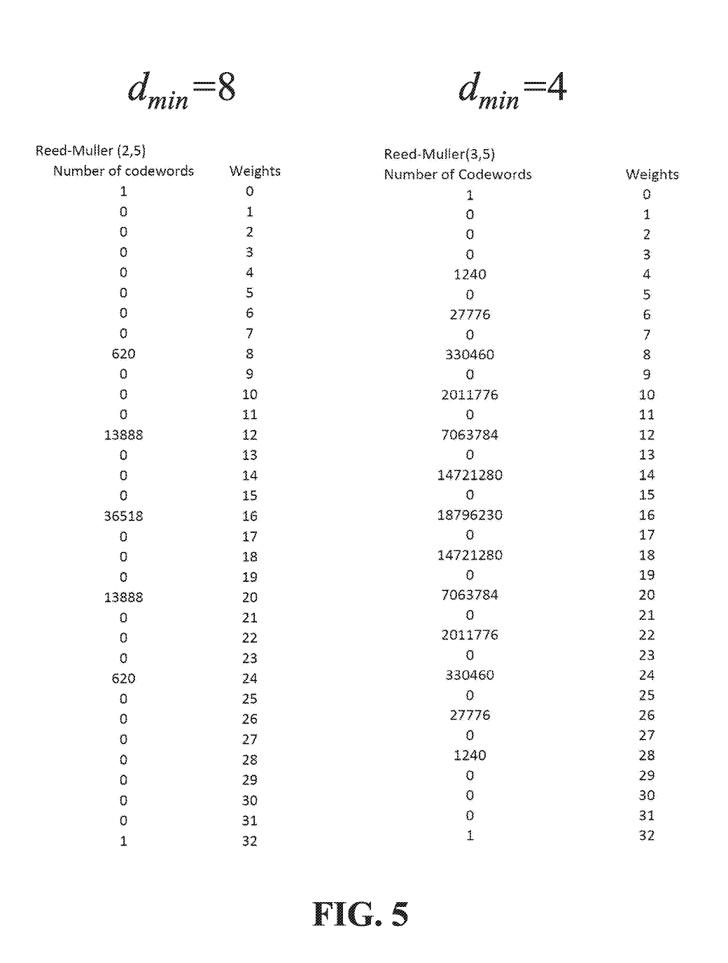

This type of subset properties could also apply to other codes as well. In FIG. 5, for example, dₘᵢₙ=8 codewords that are listed for an RM (2,5) code are a subset of the dₘᵢₙ=4 codewords of an RM (3,5) code. This could similarly apply to other values of dₘᵢₙ. For example, subset relationships could extend to dₘᵢₙ:8→6→4 or equivalently dₘᵢₙ:8←6←4, and beyond.

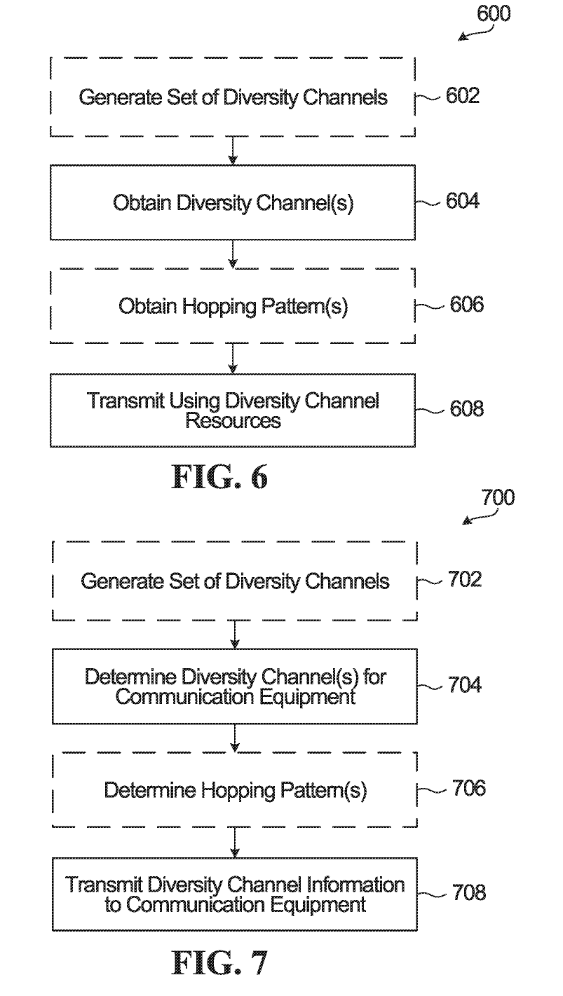

FIG. 6 is a flow diagram of an example method according to an embodiment. The example method 600 involves generating a set of diversity channels at 602, using one or more linear codes. Any of the examples disclosed herein could be used to generate the set of diversity channels at 602. Although diversity channel generation is shown in FIG. 6, diversity channels need not necessarily be generated “on the fly”, and diversity channels could be pre-generated and stored in memory for example. A set of diversity channels might not even be generated by a device or system to which diversity channels are to be assigned or allocated. For example, diversity channels that are generated by another device or system could be transmitted to communication equipment such as a UE or otherwise loaded into a memory, in a lookup table for example, at communication equipment such as a UE.

At 604, a communication equipment obtains a diversity channel, or possibly multiple diversity channels, for data transmission. The communication equipment could be a UE or network equipment. The diversity channel, or each diversity channel if multiple diversity channels are obtained, indicates communication resources that are assigned to the communication equipment. Multiple diversity channels could be assigned to the same communication equipment, for different user streams for example. A diversity channel is part of a set of diversity channels, optionally generated at 602, that is consistent with codewords of a linear code. The obtaining at 604 could involve obtaining the diversity channel(s) from a set of diversity channels stored in memory, and need not necessarily involve actually generating the set of diversity channels every time a diversity channel is needed.

Whether the set of diversity channels is generated at 602 or stored in memory, the obtaining at 604 could involve selecting the diversity channel(s) from the set. For example, a UE could receive, from network equipment, signaling that identifies the diversity channel(s). Signaling such as input parameters to control diversity channel set generation, diversity channel selection, and/or hopping pattern selection, for example, could also or instead be transmitted to network equipment by a UE or other communication equipment.

As described herein, some embodiments may involve hopping between diversity channels. In such embodiments, the obtaining at 604 involves multiple diversity channels, and one or more hopping patterns are also obtained at 606, for hopping between different ones of the diversity channels that are obtained at 604. Not every embodiment necessarily involves hopping between diversity channels, and therefore the operation shown at 606 is optional.

At 608, the UE transmits an uplink data transmission using the communication resources indicated by the diversity channel(s) obtained at 604. The data transmission could be an uplink transmission or a downlink transmission.

The example method 600 is intended for illustrative purposes. Other embodiments could include any of various features disclosed herein. For example, the set of diversity channels could be consistent with a subset of codewords of the linear code that satisfy one or more diversity channel parameters. Such diversity channel parameters could include one or n ore of: density, collision pattern, and/or other parameters.

The set of diversity channels could be consistent with combinations of codewords of the linear code and a further linear code, and/or even combinations of codewords with data or information that is not necessarily code-generated. One example of a combination relates to concatenations of codewords of the linear code and codewords of a further linear code, and/or with data or information that is not code-generated.

A diversity channel could also or instead be consistent with shortening of codewords of the linear code, by pruning or puncturing for example. Performance metrics, such as those described herein for the case of codeword combination/concatenation, could also or instead be applied in codeword shortening, by pruning/puncturing for example.

The example method 600 and the description thereof illustrate operations that could be performed at a UE or other communication equipment that uses diversity channels. FIG. 7 is a flow diagram of an example method according to another embodiment, and illustrates operations that could be performed by network equipment such as a base station.

The example method 700, like the example method 600, includes generating a set of diversity channels at 702, using one or more linear codes. It should be appreciated, however, that diversity channels could instead be pre-generated and stored in memory. At 704, one or more diversity channels for data transmission by a UE or other communication equipment, or multiple UEs or other communication equipment, are determined. Multiple diversity channels could be assigned to any UE or other communication equipment.

As disclosed herein, a diversity channel, or each diversity channel in the case of multiple diversity channels, indicates communication resources that are assigned to communication equipment. A diversity channel is part of a set of diversity channels, optionally generated at 702, that is consistent with codewords of a linear code. The determining at 704 could involve determining the diversity channel(s) for the communication equipment from a set of diversity channels stored in memory, and need not necessarily involve generating a set of diversity channels every time a diversity channel is needed.

The determining at 704 could involve selecting particular diversity channel(s) from the set. For example, one or more input parameters could be received from communication equipment. The the diversity channel(s) to be assigned to that communication equipment, a hopping pattern, and/or even the set of diversity channels, could then be determined based on the one or more input parameters.

In embodiments that involve hopping between diversity channels, the determining at 704 involves determining multiple diversity channels for communication equipment, and one or more hopping patterns are also determined at 706, for hopping between different ones of the diversity channels that are obtained at 704. The operation shown at 706 is optional, because not every embodiment necessarily involves hopping between diversity channels.

At 708, information that identifies the diversity channel(s) is transmitted to the communication equipment. In some embodiments, the set of diversity channels is stored in memory at the communication equipment, and the information includes information identifying the diversity channel(s) in the memory. In embodiments that involve hopping between diversity channels, information that identifies multiple diversity channels and a hopping pattern is transmitted to each communication equipment that is to use diversity channel hopping.

Other embodiments could include any of various features disclosed herein. For example, as described above with reference to FIG. 6, the set of diversity channels could be consistent with a subset of codewords of the linear code that satisfy one or more diversity channel parameters, such as one or more of: density, collision pattern, and/or other parameters. The set of diversity channels could be consistent with combinations, such as concatenations, of codewords of the linear code with codewords of a further linear code, and/or with data or information that is not code-generated. A diversity channel could also or instead be consistent with shortening of codewords of the linear code, by pruning or puncturing for example.

The example methods 600, 700 are illustrative of embodiments. Other embodiments could include different or additional operations. The order in which operations are performed could also be similar to or different from the order shown in FIGS. 6 and 7. Examples of additional operations that may be performed, and/or various ways to perform the illustrated operations, may be or become apparent, from examples disclosed elsewhere herein, including embodiments disclosed in the context of example apparatus or systems.

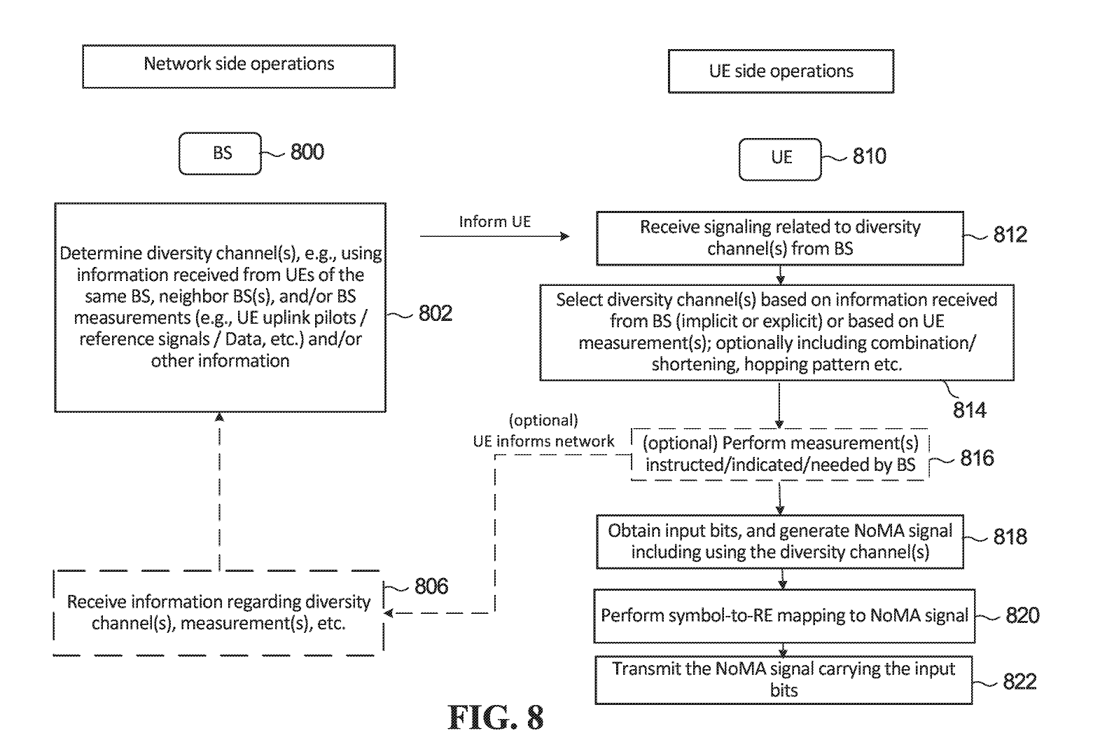

FIG. 8 is a block diagram illustrating an example of communication resource usage control signaling according to an embodiment. In FIG. 8, example network side operations are shown in the context of a BS at 800, and UE side operations are shown in the context of a UE at 810. Although only one UE 810 is shown in FIG. 8, a BS 800 could communicate with and perform the illustrated operations in conjunction with multiple UEs. FIG. 8 also represents an illustrative example that relates to uplink MA communications between a BS and a UE. Other embodiments, involving other types of communication equipment and/or downlink communications, are also possible.

Considering the network side, the BS 800 determines and assigns one or more diversity channel(s) to the UE at 802, and informs the UE 810 of the diversity channel assignment. This could use, for example, Radio Resource Control (RRC)/Downlink Control Indicator (DCI)/MAC Control Element (MAC-CE) signaling. The BS 800 could also or instead inform the UE 810 regarding constraining diversity channel pool choices, hopping pattern, measurements to be made and reported, and/or other information or parameters.

The BS 800 could explicitly signal to the UE 810 the index of the diversity channel(s), or implicitly signal diversity channel assignment by signaling parameters to enable the UE to generate or select the specific diversity channel(s) assigned to the UE.

The UE 810 could also be informed by the BS 800, through RRC/MAC-CE/DCI signaling for example, as to any scrambling/interleaving that is to be done on base codewords or diversity channels. Cell or UE/layer specific scrambling/interleaving used for other purposes could also be applied for NoMA transmissions. For example, interleavers and/or scrambling could be defined for other purposes, such as a turbo code internal interleaver or cell specific scrambling operations. Such interleaving and/or scrambling specified for another purpose could be applied to codewords or diversity channels in NoMA. Another possibility is that NoMA transmissions by default are to be scrambled/interleaved.

Although the UE 810 receives signaling related to the diversity channel(s) from the BS 800 at 812, in some embodiments a UE could derive information for diversity channel generation or selection at 814 from other information received from the BS. Received information need not necessarily be directly connected to diversity channel generation or NoMA transmission. For example, a single diversity channel or multiple diversity channels could be associated with each of different MCS settings or requirements or different lengths. The UE 810 could select a diversity channel based on UE-specific identifier such as ANTI or Demodulation Reference Signal (DM-RS), or at random.

The UE 810 could also or instead select the diversity channel(s) to be used at 814, based on its own measurements. For example, the UE 810 could select n (≥1) diversity channels that provide the highest Signal to Interference plus Noise Ratio (SINR) or avoid ‘m(≥1)’ diversity channels that provide the lowest SINR.

In some embodiments, the UE 810 could select the diversity channel(s) at 814 at random. MA signatures could be randomly assigned to UEs, and the BS 800 can then detect the diversity channel(s) being used by any UE 810. Alternatively, a diversity channel index or other identifier is associated with some other system setting such as DM-RS. Such an association could be known at the BS 800 and each UE 810, or communicated/signaled at connection initialization stages or through resource configurations or other methods.

The above examples of UE diversity channel selection at 814 are not necessarily exclusive. The UE 810 could derive the diversity channel(s) from a combination of these techniques. In one example, diversity channel index is explicitly signaled and diversity channel length/density are derived from MCS.

In some embodiments, at 816 the UE 810 performs measurements, in accordance with an instruction or indication received from the BS 800.

Using input bits and the diversity channel(s) selected at 814, a NoMA signal is generated at 818. Symbol-to-RE mapping is shown separately in FIG. 8 at 820 solely for illustrative purposes. The NoMA signal is transmitted at 822.

FIG. 8 also shows optional UE reporting. If the UE 810 uses a diversity channel having a different index than an index that was received from the BS 800 or derived by the BS, for example, then an indication of the different index could be signaled from the UE to the BS. The UE 810 could explicitly signal the index of the diversity channel(s) used, or signal an offset between a diversity channel index that was received from BS 800 and a diversity channel index derived at the UE, for example.

As described above, the UE 810 could select the diversity channel(s) based on its own measurements, in which case the UE could similarly signal the BS 800 to inform the BS of the diversity channel(s) selection. The UE 810 could also or instead signal to the BS 800 measurements such as SINR for a selected set of reference diversity channels. Other information, such as the diversity channel(s) that provide minimum and/or maximum SINR, input parameters for diversity channel generation or selection, etc., could also or instead be signaled from the UE 810 to the BS 800.

The BS 810 could obtain information to generate a set of diversity channels and/or to determine diversity channel assignments based in part on information received from the UE 810 and 806. Information reported by other UEs, of the same BS and/or neighboring BSs, could also or instead be received at 806 and taken into account in diversity channel generation and/or selection. Measurements that are reported to the BS 800 by the UE 810 and/or possibly other UEs could include, for example, SINR in the absence of NoMA transmission, SINR corresponding to particular diversity channel(s), best/worst/highest ‘n’ number and/or lowest ‘m’ number of diversity channel SINRs. A UE could also or instead report MCS, and/or desired diversity channel parameters such as any one or more of length, density, and weight. For example, the BS 800 could determine a diversity channel assignment at 802 based on an MCS received from a UE at 806 or obtain a diversity channel using other parameters.

Regarding measurements or signaling from UE s that are served by neighboring BSs, UEs at a coverage area edge of a neighboring BS could report measurements such as SINR to the BS 800. Such measurements could be used by the BS 800 to reduce or avoid severe interference caused by its own coverage area edge UEs to the coverage area edge UEs of the neighboring BS. This could similarly be applied to multiple neighboring BSs.

UE to BS signaling is optional in the example shown in FIG. 8. Measurements and/or other information that is received by the BS 800 from one or more UEs at 806 could be used to update one or more UE diversity channel assignments at 802.

FIG. 8 is intended as an illustrative example. Other embodiments could involve similar or different signaling.

Although FIG. 8 focuses on uplink communications, similar features could be implemented downlink communications. For downlink communications between a BS and a UE for example, the BS could determine its own diversity channel(s) as indicated at 802 and described above, and apply the operations shown at 818, 820, 822, in accordance with the determined diversity channel(s), for data transmission from the BS. The BS could inform the UE of the diversity channel assignment for the BS or a change of the assignment and/or related parameters, through signaling. Diversity channel assignment information could be implicitly or explicitly signaled. In this manner, the BS may inform UE to change transmission mode and/or adjust parameters of an existing transmission mode to properly receive NoMA transmission from the BS.

The UE could perform one or more measurements and report to the UE as shown at 816 and described above. The BS could instruct a UE to provide reports on demand, periodically, or at an initialization phase, for example. A UE could also or instead initialize such reports, such as when the UE is to switch to its own NoMA transmission for uplink communications. The BS could use reported information from any UE(s) for scheduling decisions, assigning MA signatures to UEs/layers, and/or adjusting or otherwise changing its own NoMA transmission, for example.

Other features that are described above in relation to uplink communications could also or instead be applied in conjunction with downlink communications.

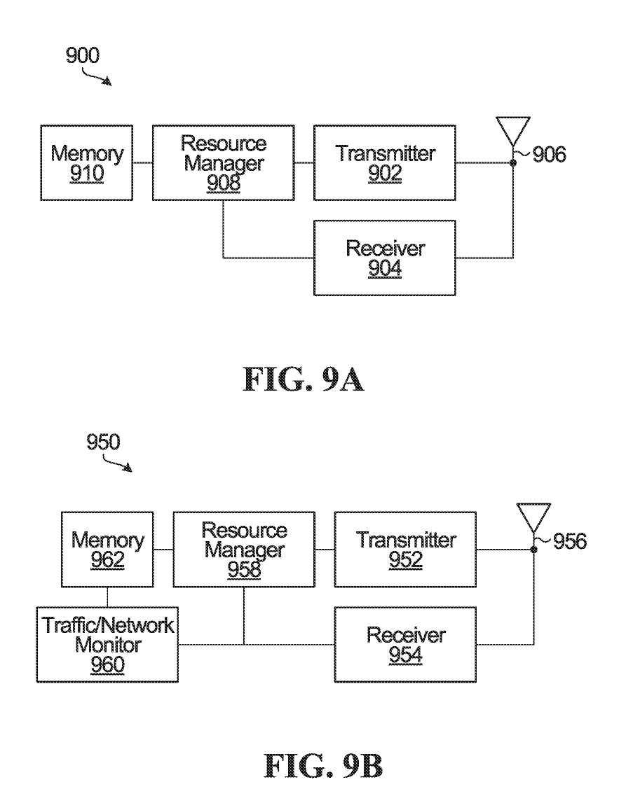

FIG. 9A is a block diagram illustrating an example UE. The example UE 900 includes a transmitter 902 and a receiver 904 coupled to one or more antennas at 906, a resource management module shown as a resource manager 908 coupled to the transmitter and to the receiver, and a memory 910 coupled to the resource manager.

In general, hardware, firmware, components which execute software, or some combination thereof might be used in implementing the transmitter 902, the receiver 904, and/or the resource manager 908. Electronic devices that might be suitable for implementing any or all of these components include, among others, microprocessors, microcontrollers, Programmable Logic Devices (PLDs), Field Programmable Gate Arrays (FPGAs), Application Specific Integrated Circuits (ASICs), and other types of “intelligent” integrated circuits.

Software that may be used in operation of the UE 900, and/or a look-up table (LUT) or other information involved in communication resource management, could be stored in the memory 910. The memory 910 includes one or more physical memory devices. Memory devices could instead be internal to one or more of the components shown in FIG. 9A. External memory devices operatively coupled to the illustrated components, or to one or more processors that implement those components, are also possible. Examples of memory devices are provided above.

The transmitter 902 could perform such operations as frequency up-conversion and modulation, and the receiver 904 could perform inverse operations, including frequency down-conversion and demodulation. The transmitter 902 and the receiver 904 could perform other operations instead of or in addition to these example operations, depending on the specific implementation and the types of communication functions and protocols to be supported. The transmitter 902 and the receiver 904 are operative to transmit and receive signals from one or more network elements a communication network.

Although a single antenna 906 is shown in FIG. 9A, a UE could include multiple antennas. Separate receive and transmit antennas or sets of multiple antennas could be provided at 906, or the same antenna or set of multiple antennas could be used for both receiving and transmitting communication signals. The antenna 906 could include one or more antennas of any of various types. The type of the antenna, or each antenna, provided at 906 could be implementation-dependent.

In some embodiments, one or more of the resource manager 908, the transmitter 902, and the receiver 904, or a processor in a processor-based embodiment, is configured to implement features disclosed herein.

FIG. 9B is a block diagram illustrating example network equipment. The example network equipment 950 includes a transmitter 952 and a receiver 954 coupled to one or more antennas at 956. The network equipment 950 also includes a resource management module shown as a resource manager 958 coupled to the transmitter 952 and a monitoring module shown as a traffic/network monitor 960, which is coupled to the receiver 954 and to a memory 962. The resource manager 958 is also coupled to the memory 962 and to the receiver 954 in the example shown.

Hardware, firmware, components that execute software, or some combination thereof might be used in implementing at least the transmitter 952, the receiver 954, the resource manager 958, and the traffic/network monitor 960. Examples of hardware, firmware, and components that execute software are described above with reference to FIG. 9A.

Software that may be used in operation of the network equipment 950, and/or an LUT or other information involved in communication resource management, could be stored in the memory 962. The memory 962 includes one or more physical memory devices. Memory devices could instead be internal to one or more of the components shown in FIG. 9B. External memory devices operatively coupled to the illustrated components, or to one or more processors that implement those components, are also possible. Examples of memory devices are provided above.

The transmitter 952 could perform such operations as frequency up-conversion and modulation, and the receiver 954, which could be integrated with the transmitter 952 in a transceiver or separately as shown, could perform inverse operations, including frequency down-conversion and demodulation. The transmitter 952 and the receiver 954 could perform other operations instead of or in addition to these example operations, depending on the specific implementation and the types of communication functions and protocols to be supported. The transmitter 952 and the receiver 954 are operative transmit communication signals to and receive communication signals from at least UEs. The same transmitter 952 and receiver 954, or a different transmitter and receiver, may enable the network equipment 950 to communicate with network elements and/or other network equipment in a communication network.

The antenna shown at 956 could include separate receive and transmit antennas or sets of antennas, or the same antenna or set of antennas could be used for both transmitting and receiving communication signals. The antenna(s) at 956 would be compatible with UE antennas to enable communications between the network equipment 950 and UEs. Network equipment may include other components, such as one or more interfaces to other network equipment, for example.

Diversity channels could be used to control communication resource usage for uplink communications and/or downlink communications by a communication equipment. The communication equipment could be a UE such as shown in FIG. 9A, or a network equipment such as shown in FIG. 9B, for example.

In an embodiment, a resource manager 908/958 in communication equipment, or a processor in a processor-based embodiment, is operative to obtain a diversity channel for data transmission. The diversity channel indicates communication resources that are assigned to the communication equipment, and includes a diversity channel from a set of diversity channels consistent with codewords of a linear code as disclosed herein. A transmitter 902/952 is operatively coupled to the resource manager 908/958 as shown, but could be coupled to a processor in a processor-based embodiment, to transmit a data transmission using the communication resources indicated by the diversity channel.

Any of various features disclosed herein could be provided in other embodiments. For example, any one or more of the following features could be provided:

the set of diversity channels is consistent with a subset of codewords of the linear code that satisfy one or more diversity channel parameters;

the one or more diversity channel parameters include one or more of: density, collision pattern, and/or other parameters disclosed herein;

a resource manager 908/958, or a processor in a processor-based embodiment, is configured to obtain the diversity channel by obtaining multiple diversity channels and a hopping pattern for hopping between different diversity channels;

the set of diversity channels is consistent with combinations such as concatenations of codewords of the linear code with codewords of a further linear code and/or with other information that is not code-generated;

the set of diversity channels is consistent with shortening of codewords of the linear code, by pruning or puncturing for example;

the communication equipment also includes a memory such as 910/962 coupled to a resource manager 908/958, or a processor in a processor-based embodiment, to store the set of diversity channels;

a resource manager 908/958, or a processor in a processor-based embodiment, is configured to obtain the diversity channel from the set of diversity channels stored in the memory;

a resource manager 908/958, or a processor in a processor-based embodiment, is further configured to generate the set of diversity channels using the linear code and any of the generation techniques disclosed herein;

the communication equipment also includes a receiver such as 904/954, coupled to a resource manager 908/958, or a processor in a processor-based embodiment, to receive from a network equipment signaling that identifies the diversity channel.

In some embodiments, determination of diversity channel assignment is handled by network equipment. For example, in one embodiment the resource manager 958, or a processor in a processor-based embodiment, is operative to determine a diversity channel for data transmission by a communication equipment. The diversity channel, as disclosed elsewhere herein, indicates communication resources that are assigned to the communication equipment and includes a diversity channel from a set of diversity channels consistent with codewords of a linear code. The transmitter 952 is operatively coupled to the resource manager 958, but would be coupled to a processor in a processor-based embodiment, to transmit to the communication equipment information that identifies the diversity channel.

Any of various features disclosed herein could be provided in other embodiments. For example, any one or more of the following features could be provided:

the set of diversity channels is consistent with a subset of codewords of the linear code that satisfy one or more diversity channel parameters;

the one or more diversity channel parameters include one or more of: density, collision pattern, and/or other parameters disclosed herein;

the resource manager 958, or a processor in a processor-based embodiment, is configured to determine the diversity channel by determining multiple diversity channels and a hopping pattern for hopping between different diversity channels;

the information further identifies the multiple diversity channels and the hopping pattern;

the set of diversity channels is consistent with combinations such as concatenations of codewords of the linear code with codewords of a further linear code and/or with other information that is not code-generated;

the set of diversity channels is consistent with shortening of codewords of the linear code, by pruning or puncturing for example;

the set of diversity channels is stored in memory at the communication device;

the information includes information identifying the diversity channel in the memory;

the resource manager 958, or a processor in a processor-based embodiment, is further configured to generate the set of diversity channels using the linear code and any of the generation techniques disclosed herein;

the network equipment also includes a receiver such as 954, coupled to the resource manager 958, or a processor in a processor-based embodiment, to receive from the UE one or more input parameters;

the resource manager 958, or a processor in a processor-based embodiment, is configured to determine one or both of the diversity channel and the set of diversity channels based on the one or more input parameters.

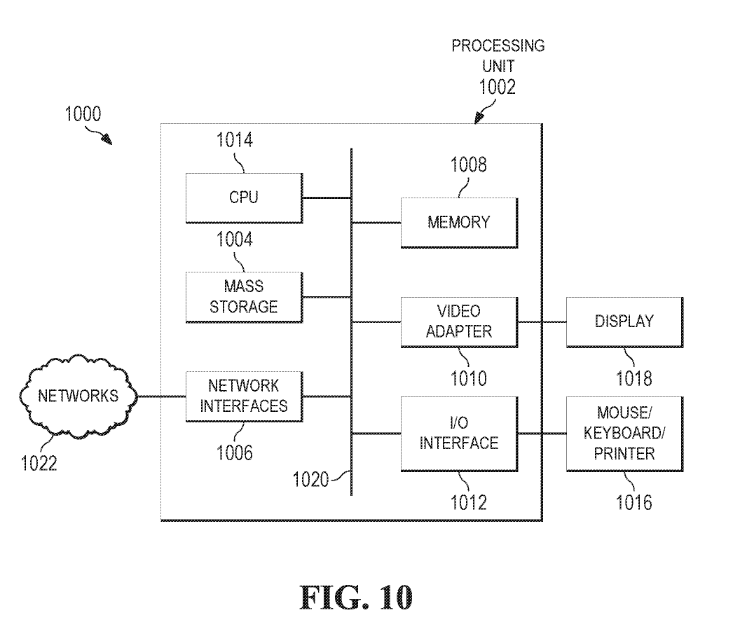

FIGS. 9A and 9B are general, high-level block diagrams of apparatus that could be implemented at a UE and network equipment, respectively. FIG. 10 is a block diagram illustrating an example computing system that may be used for implementing embodiments disclosed herein.

For example, the computing system 1000 can be any entity of UE, AN, MM, SM, UPGW, AS, or other network or user entity. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1000 includes a processing unit 1002. The processing unit includes a central processing unit (CPU) 1014, memory 1008, and may further include a mass storage device 1004, a video adapter 1010, and an I/O interface 1012 connected to a bus 1020.

The bus 1020 may be one or more of any type of several bus architectures including a memory bus or memory controller, a peripheral bus, or a video bus. The CPU 1014 may comprise any type of electronic data processor. The memory 1008 may comprise any type of non-transitory system memory such as static random access memory (SRAM), dynamic random access memory (DRAM), synchronous DRAM (SDRAM), read-only memory (ROM), or a combination thereof. In an embodiment, the memory 1008 may include ROM for use at boot-up, and DRAM for program and data storage for use while executing programs.

The mass storage 1004 may comprise any type of non-transitory storage device configured to store data, programs, and other information and to make the data, programs, and other information accessible via the bus 1020. The mass storage 1004 may comprise, for example, one or more of a solid state drive, hard disk drive, a magnetic disk drive, or an optical disk drive.

The video adapter 1010 and the I/O interface 1012 provide interfaces to couple external input and output devices to the processing unit 1002. As illustrated, examples of input and output devices include a display 1018 coupled to the video adapter 1010 and a mouse/keyboard/printer 1016 coupled to the I/O interface 1012. Other devices may be coupled to the processing unit 1002, and additional or fewer interface cards may be utilized. For example, a serial interface such as Universal Serial Bus (USB) (not shown) may be used to provide an interface for an external device.

The processing unit 1002 also includes one or more network interfaces 1006, which may comprise wired links, such as an Ethernet cable, and/or wireless links to access nodes or different networks. The network interfaces 1006 allow the processing unit 1002 to communicate with remote units via the networks. For example, the network interfaces 1006 may provide wireless communication via one or more transmitters/transmit antennas and one or more receivers/receive antennas. In an embodiment, the processing unit 1002 is coupled to a local-area network 1022 or a wide-area network for data processing and communications with remote devices, such as other processing units, the Internet, or remote storage facilities.

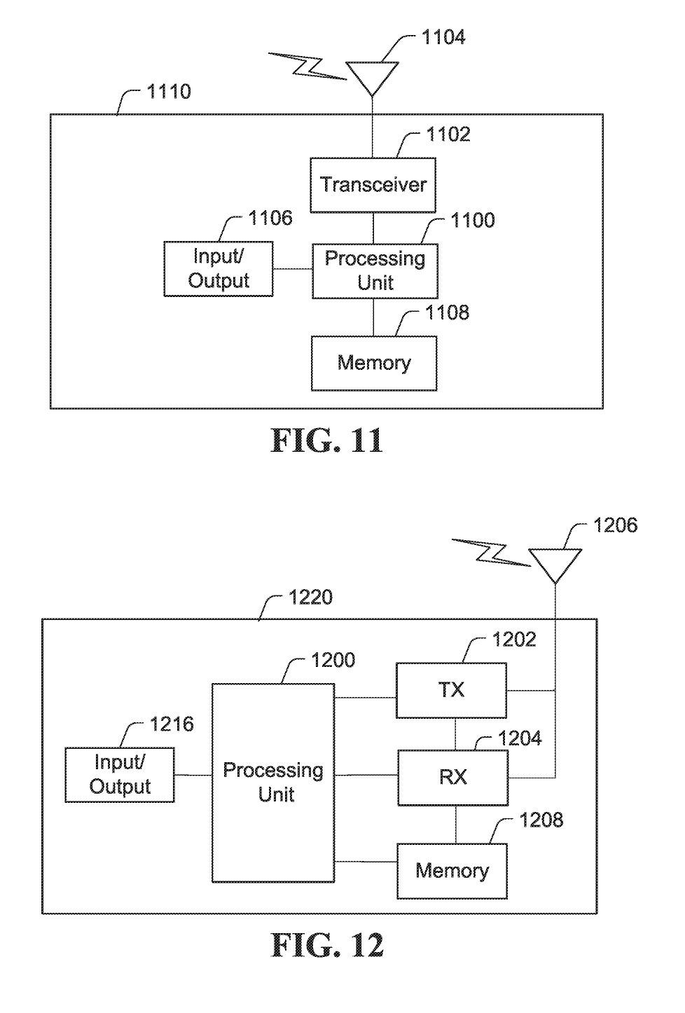

FIGS. 11 and 12 illustrate further example devices that may implement the methods and teachings according to this disclosure. In particular, FIG. 11 illustrates an example UE 1110, and FIG. 12 illustrates an example network element 1220 such as a base station. These components could be used in the communication system 100, the communication system 101, or in any other suitable system.

As shown in FIG. 11, the UE 1110 includes at least one processing unit 1100. The processing unit 1100 implements various processing operations of the UE 1110. For example, the processing unit 1100 could perform signal coding, data processing, power control, input/output processing, or any other functionality enabling the UE 1110 to operate in a communication system such as 100, 101. The processing unit 1100 may also be configured to implement some or all of the functionality and/or embodiments described in more detail herein. Each processing unit 1100 includes any suitable processing or computing device configured to perform one or more operations. Each processing unit 1100 could, for example, include a microprocessor, microcontroller, digital signal processor, field programmable gate array, or application specific integrated circuit.

The UE 1110 also includes at least one transceiver 1102. The transceiver 1102 is configured to modulate data or other content for transmission by at least one antenna or Network Interface Controller (NIC) 1104. The transceiver 1102 is also configured to demodulate data or other content received by the at least one antenna 1104. Each transceiver 1102 includes any suitable structure for generating signals for wireless or wired transmission and/or processing signals received wirelessly or by wire. Each antenna 1104 includes any suitable structure for transmitting and/or receiving wireless or wired signals. One or multiple transceivers 1102 could be used in the UE 1110. One or multiple antennas 1104 could be used in the UE 1110. Although shown as a single functional unit, a transceiver 1102 could also be implemented using at least one transmitter and at least one separate receiver.

The UE 1110 further includes one or more input/output devices 1106 or interfaces (such as a wired interface to the internet). The input/output devices 1106 permit interaction with a user or other devices in the network. Each input/output device 1106 includes any suitable structure for providing information to or receiving information from a user, such as a speaker, microphone, keypad, keyboard, display, or touch screen, including network interface communications.

In addition, the UE 1110 includes at least one memory 1108. The memory 1108 stores instructions and data used, generated, or collected by the UE 1110. For example, the memory 1108 could store software instructions or modules configured to implement some or all of the functionality and/or embodiments described above and that are executed by the processing unit(s) 1100. Each memory 1108 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 12, the base station 1220 includes at least one processing unit 1200, at least one transmitter 1202, at least one receiver 1204, one or more antennas 1206, at least one memory 1208, and one or more input/output devices or interfaces 1216. A transceiver, not shown, may be used instead of the transmitter 1202 and receiver 1204. A scheduler may be coupled to the processing unit 1200. The scheduler may be included within or operated separately from the base station 1220. The processing unit 1200 implements various processing operations of the base station 1220, such as signal coding, data processing, power control, input/output processing, or any other functionality. The processing unit 1200 can also be configured to implement some or all of the functionality and/or embodiments described in more detail above. Each processing unit 1200 includes any suitable processing or computing device configured to perform one or more operations. Each processing unit 1200 could, for example, include a microprocessor, microcontroller, digital signal processor, field programmable gate array, or application specific integrated circuit.

Each transmitter 1202 includes any suitable structure for generating signals for wireless or wired transmission to one or more UEs or other devices. Each receiver 1204 includes any suitable structure for processing signals received wirelessly or by wire from one or more UEs or other devices. Although shown as separate components, at least one transmitter 1202 and at least one receiver 1204 could be combined into a transceiver. Each antenna 1206 includes any suitable structure for transmitting and/or receiving wireless or wired signals. Although a common antenna 1206 is shown here as being coupled to both the transmitter 1202 and the receiver 1204, one or more antennas 1206 could be coupled to the transmitter(s) 1202, and one or more separate antennas 1206 could be coupled to the receiver(s) 1204. Each memory 1208 includes any suitable volatile and/or non-volatile storage and retrieval device(s) such as those described above in connection to the UE 1110. The memory 1208 stores instructions and data used, generated, or collected by the base station 1220. For example, the memory 1208 could store software instructions or modules configured to implement some or all of the functionality and/or embodiments described above and that are executed by the processing unit(s) 1200.

Each input/output device 1206 permits interaction with a user or other devices in the network. Each input/output device 1206 includes any suitable structure for providing information to or receiving/providing information from a user, including network interface communications.

Various embodiments are described in detail herein. Several features are also summarized below.

In general, diversity channels could be generated or selected based on one or more of various parameters, such as N, α, β, ρ, a number of diversity channels required, and/or possibly others. In some embodiments, codewords with suitable n and dₘᵢₙ, which could relate to system targets or requirements specified by input parameters and transformed into a code-design formulation, are generated from a suitable forward error correction/detection linear code. Generated codewords that match one or more conditions, based on α or β for example, could then be selected as a set or pool of diversity channels.

A codeword/diversity channel set or subset could be selected and refined, iteratively or otherwise, to meet one or more performance metrics. Illustrative examples of performance metrics include: codeword or diversity channel weight, maximum number of collisions, density or sparsity, codeword or diversity channel length, sum of collisions, and possibly others.

In order to produce desired diversity channels as specified by input parameters, shortening and/or combination could be applied.

The selection/refinement and shortening/combination operations outlined above could be performed in the order described, or in reverse order.

The generation, selection/refinement, and shortening/combination operations outlined above could also or instead be used to develop an iterative or non-iterative procedure or algorithm for communication resource allocation or assignment and usage control.

Input parameters and selection criteria need not necessarily be limited to N, α, β, ρ, number of diversity channels, collision/interference patterns, and/or others explicitly disclosed herein. A subset of those parameters and/or one or more other system parameters such as maximum number of interfering communication equipment/layers could also or instead be taken into account. At least some parameters could be implied rather than being explicitly determined or signaled. For example, the maximum number of possible diversity channels is bounded or limited for given N, α or β, ρ.

Combining and shortening are intended to be illustrative examples of additional operations that could be applied to codewords or diversity channels to generate a final diversity channel set or pool. Other operations such as interleaving or scrambling could also or instead be applied. A set of codewords or diversity channels could be generated as disclosed elsewhere herein, and a final set of diversity channels could then be determined by applying an interleaving operation and/or a scrambling operation. Even in such embodiments, the final diversity channels are still consistent with codewords of a linear code, as they are based at least in part on such codewords.

Examples herein in respect of collision and interference refer to only 2 users or diversity channels. These parameters, and/or others, could also or instead be defined in terms of more than 2 users or communication equipment.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by an establishing unit/module for establishing a serving cluster, an instantiating unit/module, an establishing unit/module for establishing a session link, a maintaining unit/module, and/or other performing unit(s)/module(s) for performing operations disclosed herein. The respective units/modules may be hardware, software, or a combination thereof. For instance, one or more of the units/modules may be an integrated circuit, such as field programmable gate arrays (FPGAs) or application-specific integrated circuits (ASICs). What has been described is merely illustrative of the application of principles of embodiments of the present disclosure. Other arrangements and methods can be implemented by those skilled in the art.

The contents of the drawings are intended solely for illustrative purposes, and the present invention is in no way limited to the particular example embodiments explicitly shown in the drawings and described herein. For example, FIG. 1 is a block diagram of an example communication system in which embodiments may be implemented. Other embodiments could be implemented in communication systems that include more network elements than shown, or that have different topologies than the example shown. Similarly, the examples in the other drawings are also intended solely for illustrative purposes.

Other implementation details could also vary between different embodiments.

In addition, although described primarily in the context of methods and systems, other implementations are also contemplated, as instructions stored on a non-transitory processor-readable medium, for example. The instructions, when executed by one or more processors, cause the one or more processors to perform a method.

Further example embodiments are also described below.

According to an example 1, a method involves: determining a diversity channel for data transmission by a communication equipment, wherein the diversity channel indicates communication resources that are assigned to the communication equipment, and wherein the diversity channel is from a set of diversity channels consistent with codewords of a linear code; transmitting, to the communication equipment, information that identifies the diversity channel.

An example 2 includes the method of example 1, wherein the set of diversity channels is consistent with a subset of codewords of the linear code that satisfy one or more diversity channel parameters.

An example 3 includes the method of example 2, wherein the one or more diversity channel parameters include one or more of: density and collision pattern.

An example 4 includes the method of example 1, wherein the determining involves determining a plurality of diversity channels and a hopping pattern for hopping between different diversity channels of the plurality of diversity channels, wherein the transmitting involves transmitting information that identifies the plurality of diversity channels and the hopping pattern.

An example 5 includes the method of example 1, wherein the set of diversity channels is consistent with combinations of codewords of the linear code and a further linear code.

An example 6 includes the method of example 1, wherein the set of diversity channels is consistent with concatenations of codewords of the linear code and codewords of a further linear code.

An example 7 includes the method of example 1, wherein the set of diversity channels is consistent with shortening of codewords of the linear code.

An example 8 includes the method of example 1, wherein set of diversity channels is stored in memory at the communication equipment, and wherein the information includes information identifying the diversity channel in the memory.

An example 9 includes the method of example 1, further including: generating the set of diversity channels using the linear code.

An example 10 includes the method of example 1, further including: receiving, from the communication equipment, one or more input parameters, wherein the determining involves determining one or both of the diversity channel and the set of diversity channels based on the one or more input parameters.

According to an example 11 a network equipment includes: a processor configured to determine a diversity channel for data transmission by a communication equipment, wherein the diversity channel indicates communication resources that are assigned to the communication equipment, and wherein the diversity channel is from a set of diversity channels consistent with codewords of a linear code; and a transmitter operatively coupled to the processor to transmit, to the communication equipment, information that identifies the diversity channel.

An example 12 includes the network equipment of example 11, wherein the set of diversity channels is consistent with a subset of codewords of the linear code that satisfy one or more diversity channel parameters.

An example 13 includes the network equipment of example 12, wherein the one or more diversity channel parameters include one or more of: density and collision pattern.

An example 14 includes the network equipment of example 11, wherein the processor is configured to determine the diversity channel by determining a plurality of diversity channels and a hopping pattern for hopping between different diversity channels of the plurality of diversity channels, wherein the information further identifies the plurality of diversity channels and the hopping pattern.

An example 15 includes the network equipment of example 11, wherein the set of diversity channels is consistent with combinations of codewords of the linear code and a further linear code.

An example 16 includes the network equipment of example 11, wherein the set of diversity channels is consistent with concatenations of codewords of the linear code and codewords of a further linear code.

An example 17 includes the network equipment of example 11, wherein the set of diversity channels is consistent with shortening of codewords of the linear code.

An example 18 includes the network equipment of example 11, wherein set of diversity channels is stored in memory at the communication equipment, and wherein the information includes information identifying the diversity channel in the memory.

An example 19 includes the network equipment of example 11, wherein the processor is further configured to generate the set of diversity channels using the linear code.

An example 20 includes the network equipment of example 11, further including: a receiver operatively coupled to the processor to receive, from the communication equipment, one or more input parameters, wherein the processor is configured to determine one or both of the diversity channel and the set of diversity channels based on the one or more input parameters.

According to an example 21, a non-transitory processor-readable medium stores instructions which, when executed by one or more processors, cause the one or more processors to perform a method, the method including: determining a diversity channel for data transmission by a communication equipment, the diversity channel indicating communication resources that are assigned to the communication equipment and comprising a diversity channel from a set of diversity channels consistent with codewords of a linear code; transmitting, to the communication equipment, information that identifies the diversity channel.

We claim:

1. A method comprising:
obtaining, by a communication equipment, a diversity channel for data transmission, wherein the diversity channel indicates communication resources that are assigned to the communication equipment, and wherein the diversity channel is from a set of diversity channels consistent with codewords of a linear code;
transmitting, by the communication equipment, a data transmission using the communication resources indicated by the diversity channel.

2. The method of claim 1, wherein the set of diversity channels is consistent with a subset of codewords of the linear code that satisfy one or more diversity channel parameters.

3. The method of claim 2, wherein the one or more diversity channel parameters comprise one or more of: density and collision pattern.

4. The method of claim 1, wherein the obtaining comprises obtaining a plurality of diversity channels and a hopping pattern for hopping between different diversity channels of the plurality of diversity channels.

5. The method of claim 1, wherein the set of diversity channels is consistent with combinations of codewords of the linear code and a further linear code.

6. The method of claim 1, wherein the set of diversity channels is consistent with concatenations of codewords of the linear code and codewords of a further linear code.

7. The method of claim 1, wherein the set of diversity channels is consistent with shortening of codewords of the linear code.

8. The method of claim 1, wherein set of diversity channels is stored in memory at the communication equipment, and wherein the obtaining comprises obtaining the diversity channel from the set of diversity channels stored in the memory.

9. The method of claim 1, further comprising:
generating the set of diversity channels using the linear code.

10. The method of claim 1, wherein the obtaining comprises receiving from a network equipment signaling that identifies the diversity channel.

11. A communication equipment comprising:
a processor configured to obtain a diversity channel for data transmission, wherein the diversity channel indicates communication resources that are assigned to the communication equipment, and wherein the diversity channel is from a set of diversity channels consistent with codewords of a linear code; and
a transmitter, operatively coupled to the processor, to transmit a data transmission using the communication resources indicated by the diversity channel.

12. The communication equipment of claim 11, wherein the set of diversity channels is consistent with a subset of codewords of the linear code that satisfy one or more diversity channel parameters.

13. The communication equipment of claim 12, wherein the one or more diversity channel parameters comprise one or more of: density and collision pattern.

14. The communication equipment of claim 11, wherein the processor is configured to obtain the diversity channel by obtaining a plurality of diversity channels and a hopping pattern for hopping between different diversity channels of the plurality of diversity channels.

15. The communication equipment of claim 11, wherein the set of diversity channels is consistent with combinations of codewords of the linear code and a further linear code.

16. The communication equipment of claim 11, wherein the set of diversity channels is consistent with concatenations of codewords of the linear code and codewords of a further linear code.

17. The communication equipment of claim 11, wherein the set of diversity channels is consistent with shortening of codewords of the linear code.

18. The communication equipment of claim 11, further comprising:
a memory, coupled to the processor, to store the set of diversity channels,
wherein the processor is configured to obtain the diversity channel from the set of diversity channels stored in the memory.

19. The communication equipment of claim 11, wherein the processor is further configured to generate the set of diversity channels using the linear code.

20. The communication equipment of claim 11, further comprising:
a receiver, coupled to the processor, to receive from a network equipment signaling that identifies the diversity channel.

21. A non-transitory processor-readable medium storing instructions which, when executed by one or more processors, cause the one or more processors to perform a method, the method comprising:
obtaining, by a communication equipment, a diversity channel for data transmission, wherein the diversity channel indicates communication resources that are assigned to the communication equipment, and wherein the diversity channel is from a set of diversity channels consistent with codewords of a linear code;
transmitting, by the communication equipment, a data transmission using the communication resources indicated by the diversity channel.
